(19) United States
(12) Patent Application Publication
(10) Pub. No.: US 2024/0008121 A1
(43) Pub. Date: Jan. 4, 2024

(54) METHODS AND USER EQUIPMENT FOR MANAGING PROTOCOL DATA UNIT SESSION

(71) Applicant: Samsung Electronics Co., Ltd., Suwon-si (KR)

(72) Inventors: Danish Ehsan HASHMI, Bangalore (IN); Lalith KUMAR, Bangalore (IN); Koustav ROY, Bangalore (IN); Arijit SEN, Bangalore (IN); Jagadeesh GANDIKOTA, Bangalore (IN)

(21) Appl. No.: 18/345,572

(22) Filed: Jun. 30, 2023

(30) Foreign Application Priority Data
Jul. 1, 2022 (IN) 202241037984
Apr. 10, 2023 (IN) 202341026644
Jun. 7, 2023 (IN) 202241037984

(51) Int. Cl. H04W 76/18; H04W 60/00

(52) U.S. Cl. CPC H04W 76/18; H04W 60/005

(57) ABSTRACT

The disclosure relates to a 5G or 6G communication system for supporting a higher data transmission rate. Embodiments disclosed herein relate to wireless communication networks, and more particularly to managing PDU sessions in wireless communication networks. The method maintains by a user equipment (UE), a count value for the maximum number of PDU sessions for a first access and a second access on a first network entity (NE). The UE sends a PDU session establishment request when a number of active PDU sessions is lower than the count value for the maximum number of PDU sessions or an established PDU session is released on one or more of the first access and the second access in which the maximum number of the PDU sessions has been reached.

### CROSS REFERENCE TO RELATED APPLICATIONS

This application is based on and derives the benefit of Indian Provisional Application No. 202241037984, filed Jul. 1, 2022, Indian Provisional Application No. 202341026644, filed Apr. 10, 2023, and Indian Non-Provisional Application No. 202241037984, filed Jun. 7, 2023, the contents of which are incorporated herein by reference.

### BACKGROUND

### 1. Technical

Embodiments disclosed herein relate to wireless communication networks, and more particularly to managing protocol data unit (PDU) sessions in wireless communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service-based architecture or service-based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Currently, the maximum number of protocol data unit (PDU) sessions which a user equipment (UE) can establish in a public land mobile network (PLMN) or standalone non-public network (SNPN) is limited by whichever is the lowest of: the maximum number of PDU session IDs allowed by the protocol, the PLMN's or SNPN's maximum number of PDU sessions and the UE's implementation-specific maximum number of PDU sessions.

In the current scenario, the UE sends a PDU session establishment request. The 5^{th} generation session management (5GSM) sublayer in the UE receives an indication that a 5GSM message for PDU session establishment has not been forwarded and the UE receives a rejection message PDU session establishment reject from the network entity with 5GMM cause #65 “maximum number of PDU sessions reached.” A reason to receive the rejection message may be that the PLMN's maximum number of PDU sessions has been reached. Further the UE determines the PLMN's maximum number of PDU sessions as the number of active PDU sessions the UE has upon receiving 5GMM cause #65 “maximum number of PDU sessions reached” The other reason for the rejection message may be that a standalone non public network (SNPN)'s maximum number of PDU sessions has been reached. Further, the UE determines the SNPN's maximum number of PDU sessions as the number of active PDU sessions that the SNPN has and associates the determined maximum number of PDU sessions with the entry in the “list of subscriber data” for the current SNPN, if the UE does not support access to an SNPN using credentials from a credentials holder; or the selected entry of the “list of subscriber data” or the selected PLMN subscription (if the UE supports access to an SNPN using credentials from a credentials holder).

FIG. 1 illustrates a method (100) for managing PDU sessions in wireless communication networks according to embodiments as disclosed herein. FIG. 1 depicts a scenario, where a maximum number of PDU sessions have been reached for a PLMN or SNPN. At 110, the UE (102) sends a PDU session establishment to the first PLMN (104) over 3GPP access. At 112, the UE (102) receives a rejection message for a PDU session establishment from the network with cause #65 “maximum number of PDU sessions reached.” At 114, the UE (102) identifies that the SNPN's or PLMNs maximum number of PDU sessions has been reached. At 116, the UE (102) when registered with multiple networks, the UE (102) registering with the same and different PLMNs over different access is not handled. The issue was noticed that the UE (102) identifies the SNPN's or PLMN's maximum number of PDU sessions has been reached on receiving the rejection message. No further action was taken on receiving the rejection message when the UE (102) registers itself with the same and different PLMNs over different access.

The principal object of the embodiments herein is to disclose methods and a user equipment (UE) for managing PDU sessions in wireless communication networks.

Another object of the embodiments herein is to disclose methods and the user equipment (UE) for managing PDU sessions in wireless communication networks, that maintains a common count value for the maximum number of PDU sessions for a first access and a second access on a first public land mobile network (i.e., first PLMN), when the first PLMN for the first access and the second access is same.

Another object of the embodiments herein is to disclose the methods and the user equipment (UE) for managing PDU sessions in wireless communication networks, wherein a PDU session establishment request is sent, if the number of active PDU session is lower than the count value for the maximum number of PDU session.

Another object of the embodiments herein is to disclose the methods and the user equipment (UE) for managing PDU sessions in wireless communication networks, wherein a PDU session establishment request is sent, if an established PDU session is released on one or more of the first access and the second access in which the maximum number of PDU session has been reached.

Another object of the embodiments herein is to disclose the methods and the user equipment (UE) for clearing the count value for the first PLMN of the maximum number of PDU session when the first PLMN is no longer registered over both of the first access and the second access, if the user equipment gets successfully registered with a second public land mobile network (i.e., second PLMN) moving from the first PLMN.

Another object of the embodiments herein is to disclose the method and the user equipment (UE) for maintaining a first count value for a PDU session for first PLMN (104) and a second count value for a second access on the second public land mobile network (i.e., second PLMN).

Another object of the embodiments herein is to disclose the methods and the user equipment (UE) for sending a PDU session establishment request, if the number of active PDU sessions is lower than the first count value and the second count value for the maximum number of PDU session.

Another object of the embodiments herein is to disclose the method and the user equipment (UE) for clearing the first count value for the first access in the first PLMN of the maximum number of protocol data unit (PDU) session; and maintaining the second count value for the second access in the second public land mobile network, if the user equipment gets successfully registered with a third public land mobile network (third PLMN) moving from the first PLMN for the first access.

Another object of the embodiments herein is to disclose the methods and the user equipment (UE) for sending a PDU session establishment request, if the number of active PDU session is lower than the first count value in the first PLMN when the second count value for second PLMN has reached the maximum number of PDU session.

Another object of the embodiments herein is to disclose the methods and the user equipment (UE) for sending the PDU session establishment request, if the number of active PDU session is lower than the second count value in the second PLMN when the first count value for first PLMN has reached the maximum number of PDU session.

### SUMMARY

An embodiment relates to a method for managing protocol data units (PDUs) sessions in a wireless communication environment, the method comprises maintaining, by a user equipment (UE), a count value for the maximum number of PDU sessions for a first access and a second access on a first network entity (NE). The count value is common for the first access and the second access when the first NE for the first access and the second access is same. The UE sends a PDU session establishment request, upon determining that one of: a number of active PDU session is lower than the count value for the maximum number of PDU session and an established PDU session is released on one or more of the first access and the second access in which the maximum number of the PDU session has been reached.

An embodiment relates to a method, performed by a user equipment (UE), in a wireless communication system, the method comprises maintaining, by a user equipment (UE), a first count value for a maximum number of protocol data unit (PDU) session for a first access on a first network entity and a second count value for a second access on the second network entity. The UE sends a PDU session establishment request, upon determining that a number of active PDU session is lower than the first count value and the second count value for the maximum number of PDU session and an established PDU session is released on one or more of the first access and the second access in which the maximum number of PDU session has been reached.

An embodiment relates to a user equipment (UE) in a wireless communication system. the UE comprising a transceiver; and at least one controller coupled with the transceiver and configured to maintain, a count value for the maximum number of PDU sessions for a first access and a second access on a first network entity (first NE). The count value is common for the first access and the second access when the first NE for the first access and the second access is same. The UE send a PDU session establishment request upon determining a number of active PDU session is lower than the count value for the maximum number of PDU session and an established PDU session is released on one or more of the first access and the second access in which the maximum number of PDU session has been reached.

An embodiment relates to a user equipment (UE) in a wireless communication system, wherein the UE comprising a transceiver; and at least one controller coupled with the transceiver and configured to maintain, a count value for the maximum number of PDU sessions for a first access and a second access on a first network entity. The count value is common for the first access and the second access when the first NE for the first access and the second access is same. The UE sends a PDU session establishment request upon determining a number of active PDU session is lower than the count value for the maximum number of PDU session and an established PDU session is released on one or more of the first access and the second access in which the maximum number of PDU session has been reached.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

[Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 illustrates an example of a method for managing PDU sessions in wireless communication networks according to embodiment of the present disclosure.

FIG. 2A illustrates an example of wireless network for managing PDU sessions when a UE is connected to a first PLMN for a first access and a second access according to embodiments as disclosed herein;

FIG. 2B illustrates an example of wireless network for managing PDU sessions when the UE is connected to the first PLMN for the first access and a second access according to embodiments as disclosed herein.

FIG. 3A illustrates an example of a method for managing PDU sessions in wireless communication networks for the UE registered for the first access and the second access to the first PLMN according to embodiments as disclosed herein.

FIG. 3B illustrates an example of scenario of method for managing PDU sessions in wireless communication networks for the UE registered for the first access and the second access to the first PLMN according to embodiments as disclosed herein.

FIG. 4A illustrates an example of flowchart of method for managing PDU sessions in wireless communication networks for the UE registered for the first access and the second access to the first PLMN according to embodiments as disclosed herein.

FIG. 4B illustrates an example of scenario of method for managing PDU sessions in wireless communication networks for the UE registered for 3GPP access and non-3GPP access to the first PLMN according to embodiments as disclosed herein.

FIG. 5A illustrates an example of wireless network for managing PDU sessions for the UE registered with the first PLMN for first access and second PLMN for the second access according to embodiments as disclosed herein.

FIG. 5B illustrates an example of wireless network for managing PDU sessions for the UE registered with the first PLMN for first access and second PLMN for the second access according to embodiments as disclosed herein.

FIG. 6A illustrates an example of flowchart of method for managing PDU sessions in wireless communication networks for the UE registered for 3GPP access to the first PLMN and non-3GPP access to the second PLMN according to embodiments as disclosed herein.

FIG. 6B illustrates an example of of scenario of method for managing PDU sessions in wireless communication networks for the UE registered for 3GPP access to the first PLMN and non-3GPP access to the second PLMN according to embodiments as disclosed herein.

FIG. 7A illustrates an example of flowchart of method for managing PDU sessions in wireless communication networks for the UE registered for 3GPP access to the first PLMN and non-3GPP access to the second PLMN according to the embodiments as disclosed herein.

FIG. 7B illustrates an example of scenario for UE registered for 3GPP access to the first PLMN and non-3GPP access to the second PLMN according to embodiments as disclosed herein.

### DETAILED DESCRIPTION

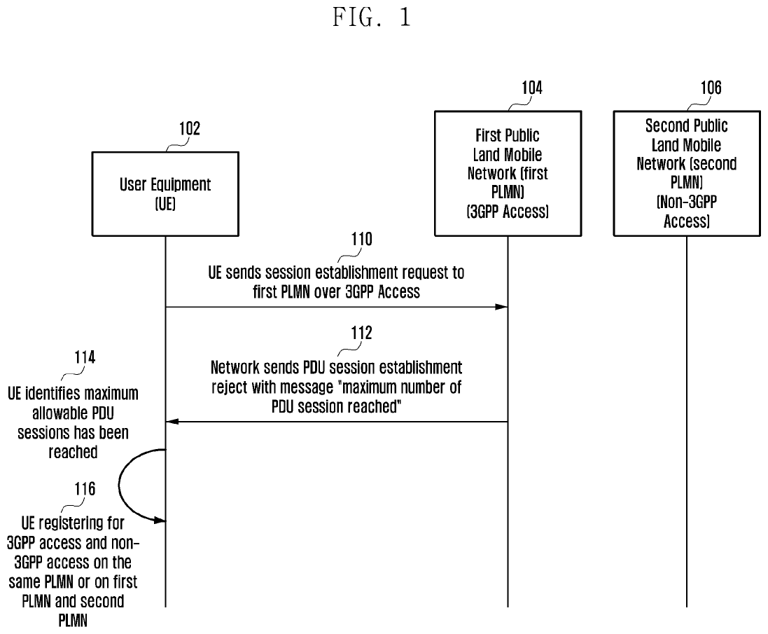

FIGS. 1 through 7B discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

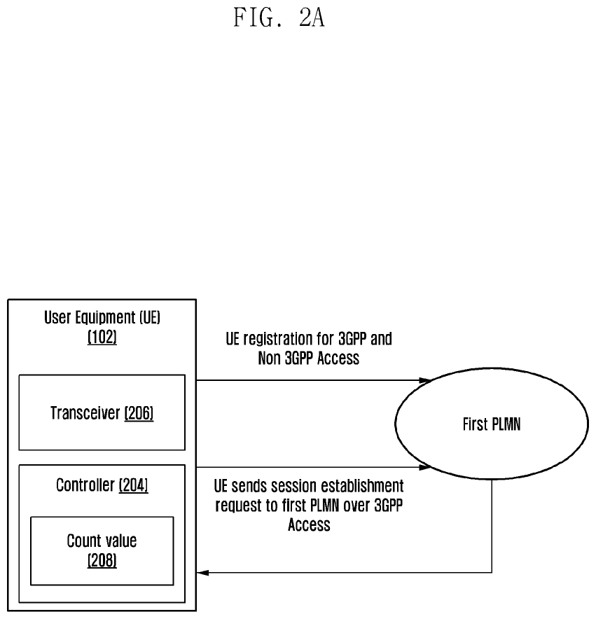

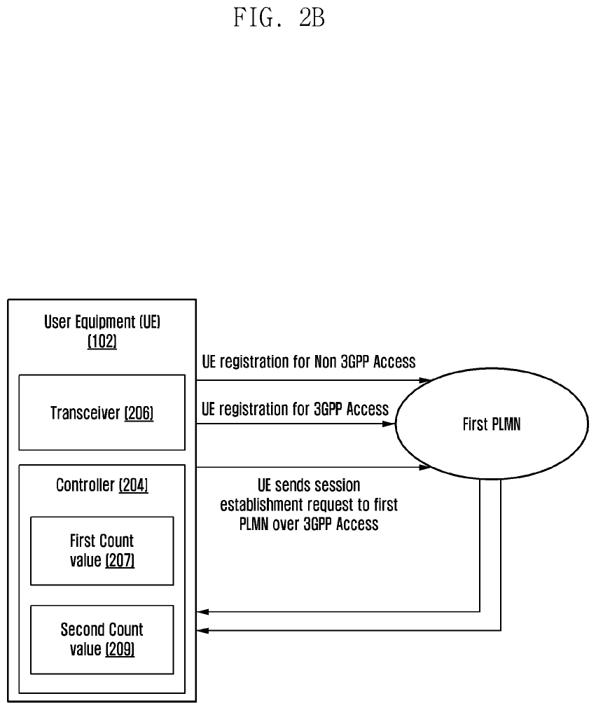

The embodiments herein achieve methods and user equipment (UE) for managing protocol data units (PDU) sessions. Referring now to the drawings, and more particularly to FIGS. 2 through 7B, where similar reference characters denote corresponding features consistently throughout the figures, there are shown example embodiments.

The following abbreviations and definitions have been referred to herein:
NSAC: Network Slice Admission Control;
NSACF: Network Slice Admission Control Function;
AMF: Access and Mobility Management Function;
NEF: Network Exposure Function;
NF: Network Function;
NSSAI: Network Slice Selection Assistance Information;
NSSF: Network Slice Selection Function;
S-NSSAI: Single Network Slice Selection Assistance Information;
SMF: Session Management Function;
UPF: User Plane Function;
SNPN: Stand-alone Non-Public Network;
PDU: protocol Data Units;
SNPN: Standalone Non Public Network; and
PLMN: Public Land Mobile Network.

FIG. 2A illustrates an example of wireless network for managing protocol data units (PDU) sessions according to embodiments as disclosed herein. The wireless network (200) can be, for example, but not limited to a 4^{th} generation wireless network, a 5^{th} generation wireless network, open radio access network (ORAN) or the like. The wireless network (200) includes the UE (102) and a network entity (NE) (210). The network entity may be a PLMN or an SNPN. The UE (102) may be, for example, but not limited to a laptop, a smart phone, a desktop computer, a notebook, a device-to-device (D2D) device, a vehicle to everything (V2X) device, a foldable phone, a smart TV, a tablet, a television, a connected car, an immersive device, and an internet of things (IOT) device. The UE (102) is registered with a first public land mobile network (i.e., first PLMN (104)) for a first access and a second access. The first access and the second access comprise one or more of a 3GPP access and a non-3GPP access. The UE (102) is in communication with the first PLMN (104) for establishing the PDU session.

The UE (102) comprises a controller (204) and a transceiver (206). The controller (204) communicates to the first PLMN (104) through the transceiver (206). The controller (204) sends the PDU session establishment request to the first PLMN (104) (204) for the first access through the transceiver (206). The controller (204) may receive a rejection message for the PDU session establishment request for the first access from the first PLMN (104) when the maximum number of PDU session has been reached.

In an embodiment herein, the rejection message comprises a 5G Mobile management (5GMM), 5G Non access stratum mobile management (NAS-MM) with an indication or cause indicating “maximum number of PDU sessions reached” message.

In an embodiment herein, the UE (102) maintains a count value (208) for the number of active PDU sessions for a first access and a second access on the first PLMN (104). As the UE (102) is registered with the same first PLMN (104) for the first access and the second access, the count value is common for the first access and the second access (i.e., count value is the sum of active PDU session on the first access and the second access). When the UE (102) is registered on the same PLMN for both 3GPP access and non-3GPP access, there is only one maximum number of PDU sessions for a PLMN, and therefore the count value is common between the first access and the second access. In an embodiment, maximum number of PDU sessions is the total active PDU session on the first access and the second access at the time UE received “maximum number of PDU sessions reached.”

In an embodiment herein, the controller (204) performs a check if the count value for the maximum number of PDU session has been reached before sending a PDU session establishment request for any type of access, (which can be the first access or the second access). If the result of the check is that the count value is lower than the maximum number of PDU session, then the controller sends the PDU session establishment request for the first access or the second access to the first PLMN (104).

In an embodiment herein, the controller (204) checks if the first access and the second access in which the maximum number of PDU session has been reached been released. If at least one of the first access and the second access, the established PDU session is released. The controller (204) further sends the PDU session establishment request to the first PLMN (104) for at least one of the first access or the second access on which the established PDU session has been released.

In an embodiment herein, the UE (102) migrates or moves from first PLMN (104) to another PLMN (i.e., second PLMN (106)). Once the UE (102) gets successfully registered on the second PLMN (106), the controller (204) clears the count value for the first PLMN (104) of the maximum number of PDU sessions. The count value is cleared, when the first PLMN (104) is no longer registered over both of the first access and the second access.

In an embodiment herein, the network entity (NE) may comprise a standalone non-public (SNPN) network. The UE register over the SNPN over the first access and the second access.

In an embodiment UE is registered on PLMN then message maximum number of PDU session is referred as PLMN's maximum number of PDU sessions and if UE is registered on SNPN then maximum number of PDU session is referred as SNPN's maximum number of PDU sessions.

In an embodiment herein, the first PLMN (104), the second PLMN (106), or any public land mobile network (PLMN) registers via the SNPN over the first access and the second access.

In an embodiment herein, the UE (102) supports access to an SNPN using credentials from a credential's holder and/or equivalent SNPNs. Once the UE (102) is registered over the SNPN for the 3GPP access or non-3GPP access for a selected entry of the “list of subscriber data,” the controller (204) checks if the count value for the maximum number of PDU sessions. If the count value for the maximum number of PDU sessions has been reached for the first SNPN in the selected entry of the “list of subscriber data,” the UE (102) may move to the second SNPN (106) in the same selected entry. In an embodiment herein, the UE (102) is registered over the SNPN for the 3GPP access or non-3GPP access for a selected PLMN subscription. The controller (204) checks if the count value for the active number of PDU sessions. If the count value for the maximum number of PDU sessions has been reached for the first SNPN for the selected PLMN subscription, the UE (102) may move to the second SNPN (106) in the same selected entry. The controller (204) maintains the count value which is common for the first access and the second access in the selected entry of the “list of subscriber data” or the selected PLMN subscription, as the UE (102) is registered on first SNPN for both, 3GPP access and non-3GPP access.

In an embodiment herein, the controller (204) checks if the SNPN's maximum number of PDU sessions has been reached. If the SNPN's maximum number of PDU sessions has been reached, then the UE (102) determines the SNPN's maximum number of PDU sessions as the number of currently active PDU sessions and associates the determined maximum number of PDU sessions with the entry in the “list of subscriber data” for the current SNPN (if the UE (102) does not support access to an SNPN using credentials from a credentials holder and equivalent SNPNs).

In an embodiment herein, if the UE (102) supports access to an SNPN using credentials from a credential's holder, equivalent SNPNs or both, the controller (204) checks if the SNPN's maximum number of PDU sessions have been reached. If the SNPN's maximum number of PDU sessions have been reached, then the UE (102) determines the SNPN's maximum number of PDU sessions as the number of currently active PDU sessions and associates the determined maximum number of PDU sessions with the selected entry of the “list of subscriber data” or the selected PLMN subscription.

In an embodiment herein, each entry of the “list of subscriber data” in case of the UE (102) supports access to an SNPN using credentials from a credentials holder, the SNPN selection parameters, consisting of: a user controlled prioritized list of preferred SNPNs, where each entry contains an SNPN identity; the credentials holder controlled prioritized list of preferred SNPNs, where each entry contains an SNPN identity; and the credentials holder controlled prioritized list of group IDs for network selection (GINs).

In an embodiment herein, the controller (204) determines the count value for maximum number of PDU session. The controller (204) checks during a UE (102)-requested PDU session establishment procedure whether the 5GSM sublayer in the UE (102) has received an indication that the 5GSM message was forwarded or not. If the controller has received an indication from PLMN that the 5GSM message was not forwarded due to rejection with 5GMM cause #65 “maximum number of PDU sessions reached,” then the controller (204) determines that the number of active PDU sessions of the PLMN has reached the PLMN's maximum number of PDU sessions.

In an embodiment herein, if the controller (204) receives an indication from the SNPN that the 5GSM message has not been forwarded due to rejection message with 5GMM cause #65 “maximum number of PDU sessions reached,” then the UE (102) determines the number of active PDU sessions of the SNPN has reached the SNPN's maximum number of PDU sessions SNPN. Then, the controller (204) associates the determined SNPN's maximum number of PDU sessions with the entry in the “list of subscriber data” for the current SNPN, if the UE (102) does not support access to an SNPN using credentials from a credentials holder and equivalent SNPNs. In an embodiment herein, if the UE (102) supports access to an SNPN using credentials from a credentials holder, and/or equivalent SNPNs, the controller (204) then associates the determined maximum number of PDU sessions with the selected entry of the “list of subscriber data” or the selected PLMN subscription.

TABLE 1

| | | Credentials holder | | |
|---|---|---|---|---|
| | User controlled | controlled | | |
| Entry | prioritized list of | prioritized list of | Equivalent | |
| no. | preferred SNPNs | preferred SNPNs | SNPN | Credential |
| 1 | S1, S2, S3 | S1, S2, S3, | S4, S5 | X |
| | | S4, S5, S6 | | |
| 2 | S2, S1 | S2 | none | Y |
| 3 | S5, S1 | S6, S8, S9 | S6, S8 | Z |

TABLE 2

| | | Credentials holder | | |
|---|---|---|---|---|
| | User controlled | controlled | | |
| Entry | prioritized list of | prioritized list of | Equivalent | PLMN |
| no. | preferred SNPNs | preferred SNPNs | SNPN | Subscription |
| 1 | S1, S2, S3 | S1, S2, S3, | S4, S5 | X |
| | | S4, S5, S6 | | |
| 2 | S2, S1 | S2 | none | Y |
| 3 | S5, S1 | S6, S8, S9 | S6, S8 | Z |

In an embodiment herein, in an example scenario, as shown in Table 1, generally, each entry associated with the list of subscriber data has the SNPN selection parameters (e.g., preferred SNPN). Table 1 shows the list of subscriber's data. The S1, S2, S3 . . . Sn are a SNPN identifier (SNPN ID). The UE maintains the SNPN's maximum number of PDU session per entry. For example, a user selects entry no. 1, the rejection message is received with 5GMM cause “maximum number of PDU sessions reached,” SNPN's maximum number of PDU session is added to the entry no. 1, and other entries are not impacted.

In an embodiment herein, in an example scenario, as shown in Table 2 for the PLMN subscription, generally, each entry associated with the PLMN subscription has the SNPN selection parameters (e.g., preferred SNPN). The UE maintains the SNPN's maximum number of PDU session per entry. For example, a user selects entry no. 1, the rejection message with 5GMM cause “maximum number of PDU sessions reached” is received, SNPN's maximum number of PDU session is added to the entry no. 1, and other entries are not impacted.

In the current scenario, this may not be the case when the UE is registered on 3GPP access and non-3GPP access on the same SNPN or a different SNPN for each of the access. In an example scenario, suppose the entry no. 1 is selected and the UE receives a rejection message for the 4^{th} PDU session according to the general practice, the UE maintains the count value for SNPN's maximum PDU session for the entry no. 1 as 4 (a=4) and so on as shown in Table 3 below.

TABLE 3

| Entry no. | Count for maximum number of PDU session |
|---|---|
| 1 | A |
| 2 | B |
| 3 | C |

In the current scenario, for a UE register with the first SNPN, and the UE supports credential from credential holder or the PLMN subscription, when the UE moves from the first SNPN to the second SNPN for the same entry, e.g., entry no. 1 as shown in Table 1 or Table 2, the SNPN's maximum PDU session for the entry no 1 is not deleted for the entry no. 1 for the SNPN as the count value is not maintained for each SNPN in the selected entry.

In an embodiment herein, in an example scenario, as shown in Table 4, the UE maintains the SNPN's maximum number of PDU session for each entry associated with the PLMN subscription or list of subscriber data per access type separately (the 3GPP access and the non-3GPP access). For example, a user selects entry no. 1, the rejection message with 5GMM cause “maximum number of PDU sessions reached” is received, on first access SNPN's maximum number of PDU session is added to the entry no. 1 on first access (e.g., −a1). The rejection message with 5GMM cause “maximum number of PDU sessions reached” is received, on second access then SNPN's maximum number of PDU session is added to the entry no. 1 on second access (e.g., −a2). UE can initiate the PDU session establishment on 3GPP access in the selected entry 1 when the number of active PDU session in the first access (3GPP) is less than a1 and the. UE can initiate the PDU session establishment on non-3GPP access in the selected entry 1 when number of active PDU session in the second access (non-3GPP) is less than a2.

TABLE 4

| | Count for maximum number | Count for maximum number |
|---|---|---|
| | of PDU session - | of PDU session - |
| Entry no. | 3GPP access | non-GPP access |
| 1 | a1 | a2 |
| 2 | b1 | b2 |
| 3 | c1 | c2 |

In an embodiment herein, a network for the transceiver comprises at least one of an access and mobility function (AMF), a session management function (SMF), and a 5G core network function.

In an embodiment herein, the PDU session comprises a normal PDU session, and a MA multi-access PDU (MA-PDU) session.

FIG. 2B illustrates an example of wireless network for managing protocol data units (PDU) sessions according to embodiments as disclosed herein. In an embodiment herein, the UE (102) is registered with the first PLMN (104) for the first access and the second access. The first access and the second access comprise one or more of a 3GPP access and a non-3GPP access. The UE (102) maintains a separate count value (208) for the maximum number of PDU sessions for the first access and the second access on the first PLMN (104). The controller (204) maintains a first count value (207) for the first access and a second count value (209) for the second access. As the UE (102) is registered with the same first PLMN (104) for the first access and the second access, the count value is kept separate for the first access and the second access in the present embodiment.

In an embodiment herein, the controller (204) performs a check for whether the maximum number of PDU sessions has been reached for both 3GPP access and non-3GPP access. If any one of the access has the first count value or the second count value lower than the maximum number of PDU sessions, the controller (204) sends a PDU establishment request to the first PLMN (104) for 3GPP access or non-3GPP access. The controller (204) sends the PDU session establishment request for the first access, if the first count value is lower than the maximum number of PDU sessions in the first PLMN (104) and the second count value for second PLMN (106) has reached the maximum number of PDU session.

In an embodiment herein, the controller (204) sends the PDU session establishment request for the second access, if the second count value is lower than the maximum number of PDU sessions in the second PLMN (104) when the first count value for the second PLMN (106) has reached the maximum number of PDU sessions.

The embodiments disclosed herein can be implemented through at least one software program running on at least one hardware device and performing network management functions to control the elements. The elements shown in FIGS. 2A and 2B may be at least one of a hardware device, or a combination of hardware device and software module.

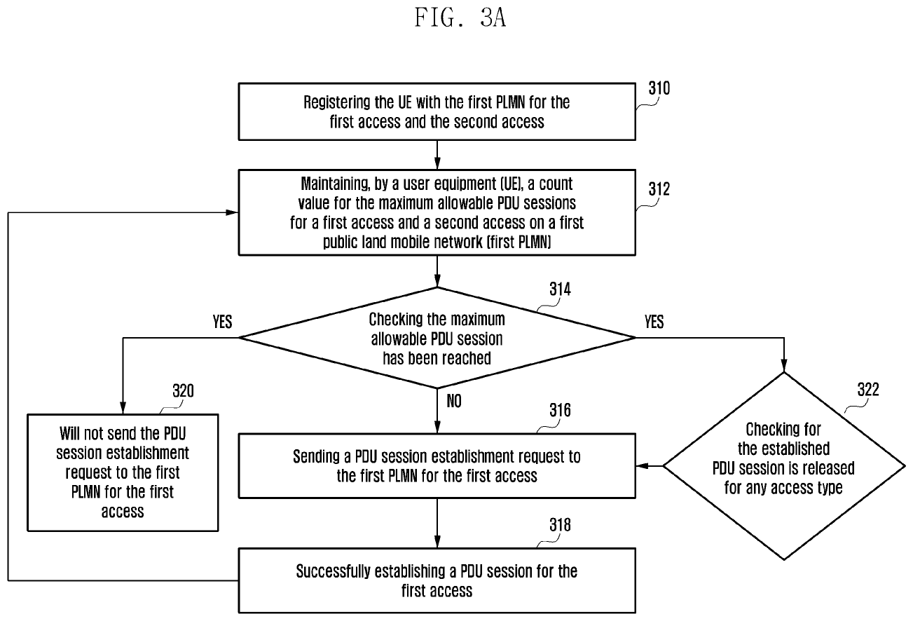

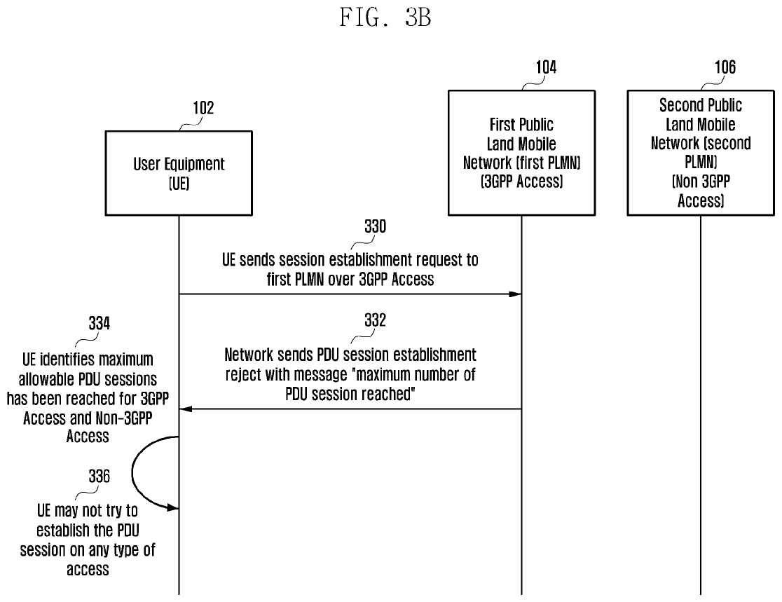

FIG. 3A illustrates an example of flowchart of method for managing PDU sessions in wireless communication networks for the UE (102) registered for 3GPP access and Non-3GPP access to the first PLMN (104) according to embodiments as disclosed herein.

At step 310, the UE (102) registers with the first PLMN (104) for the first access and the second access. The first access and the second access may be one of the 3GPP access or the non-3GPP access. At step 312, the UE (102) maintains the count value for the active number of PDU sessions for the first access and the second access for the first PLMN (104). As the UE (102) is registered with the first PLMN (104) for both the first access and the second access, the count value is common for both types of access (i.e., the first access and second access). The count value is the maximum number of PDU sessions for the first access in addition to the maximum number of PDU sessions for the second session.

For example, if the maximum number of PDU sessions for the first access is 3 and the maximum number of PDU sessions for the second session is 5, then the count value for the maximum number of PDU sessions on the first PLMN (104) is 8. At step 314, the UE (102) checks if the count value for the maximum number of PDU sessions on the first PLMN (104) has been reached or not; i.e., the UE (102) checks if the number of active PDU sessions. If the count value is lower than the maximum number of PDU sessions on first PLMN (104), in step 316, the UE (102) sends the PDU session establishment request for the first access or the second access to the first PLMN (104). At step 318, as the PDU session has been established successfully with the first PLMN (104) for the first access or the second access for which the PDU session establishment request was sent. The count value is updated and maintained after establishing the PDU session for a 3GPP access or non-3GPP access.

In an embodiment herein, if the count value for the active number of PDU session is equal to the maximum number of PDU sessions has been reached, in step 320, the UE (102) may not send any further PDU establishment requests to the first PLMN (104). In an embodiment herein, if the count value for the maximum number of PDU sessions has been reached, in step 322, the UE (102) checks continuously if any established PDU sessions for the first access and the second access has been released or not. If any one of the PDU sessions for the first access and the second access has been released, the UE (102) may send a PDU establishment request to the first PLMN (104) for any type of access, i.e., either 3GPP access or non-3GPP access.

In an embodiment herein, the UE (102) may migrate or move from the first PLMN (104) to the second PLMN (106). Once the UE (102) gets successfully registered on the second PLMN (106), the UE (102) clears the count value for the first PLMN (104) of the maximum number of PDU sessions only when the first PLMN (104) is no longer registered over both of the first access and the second access on the first PLMN (104).

In an embodiment herein, the first PLMN (104), the second PLMN (106) or any public land mobile network may comprise a standalone non-public (SNPN) network. The SNPN registers via the PLMN over the first access and the second access.

In an embodiment herein, the first PLMN (104), the second PLMN (106), or any public land mobile network (PLMN) registers via the SNPN over the first access and the second access.

FIG. 3B illustrates an example of scenario of method for managing PDU sessions in wireless communication networks for the UE (102) registered for 3GPP access and Non-3GPP access to the first PLMN (104) according to embodiments as disclosed herein. Herein, the UE (102) is registered over the same PLMN for 3GPP access and non-3GPP access. At step 330, the UE (102) registers with the first PLMN (104) over both the 3GPP access and the non-3GPP access. The UE (102) sends the PDU session establishment to the first PLMN (104) over 3GPP access. In the current scenario, the network entity (NE) may be a SNPN network. At step 332, the UE (102) receives the rejection message for the PDU session establishment from network entity that is the first PLMN (104) with 5GMM cause #65 “maximum number of PDU sessions reached” for 3GPP access. In step 334, the UE (102) checks if the number of active PDU sessions has been reached for the first PLMN (104) and maintains the number of active PDU sessions as the count value for 3GPP access on the first PLMN.

For example, if the UE (102) receives the rejection message for PDU session establishment with 5GMM Cause #65 “maximum number of PDU sessions reached” in the 3GPP access, then the UE (102) may check the maximum number of PDU session for both the 3GPP access and non-3GPP (N3GPP) access for the first PLMN, and maintain the maximum number of PDU sessions as the count value for the maximum number of PDU session. So, the UE (102) may maintain the same count value of the number of PDU sessions for the first access and the second access for the first PLMN.

For example, the UE (102) has 5 PDU sessions established on 3GPP access registered with the first PLMN (104), and the UE (102) has 3 PDU sessions established on non-3GPP access registered with the first PLMN (104). If the UE (102) receives the rejection message for PDU session establishment with 5GMM Cause #65 “maximum number of PDU sessions reached” in either 3GPP access or non-3GPP access, then the UE (102) may maintain 8 as the maximum number of PDU sessions allowed for this PLMN ID over the first access and the second access of the UE (102).

The UE (102) may not attempt to send a PDU session establishment request when the number of active PDU sessions exceeds 8 on any access type. The UE (102) is allowed to send the PDU session establishment request till the count value reaches 8 on the 3GPP access or the non-3GPP access.

In an embodiment herein, consider that the UE (102) receives the rejection message that the maximum number of established PDU sessions has been reached for the UE (102) and the upper layers of the UE (102). The UE (102) may not send the PDU session establishment request to a data network name (DNN) over 3GPP access and non-3GPP access, unless an established PDU session is released on any of the access type in which the maximum number of PDU sessions has been reached. For example, if the UE (102) has 8 PDU sessions and the UE (102) is maintaining 8 as the maximum number of PDU sessions, then at least one of the 8 PDU sessions over either 3GPP access or non-3GPP access may be released in order for the UE (102) to attempt to establish another PDU session over either 3GPP access or non-3GPP access.

In an embodiment herein, consider that the UE (102) moves from the first PLMN (104) to the second PLMN (106) for the first access or the second access. The UE (102) may clear the previous count values representing the first PLMN (104)'s maximum number(s) of PDU sessions. For example, if the UE (102) has 8 PDU sessions and the UE (102) is maintaining 8 as the maximum number of PDU sessions, then if the UE (102) registers with the second PLMN (106) for 3GPP access, the UE (102) may clear the count value that was 8 for the first PLMN (104), given that the first PLMN (104) is no longer registered on both of the 3GPP access and non-3GPP access.

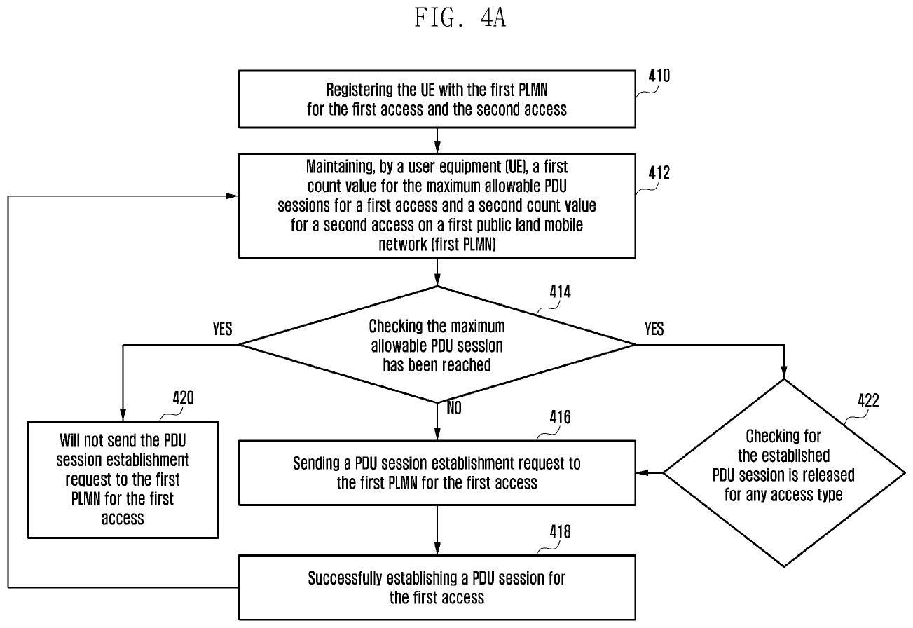

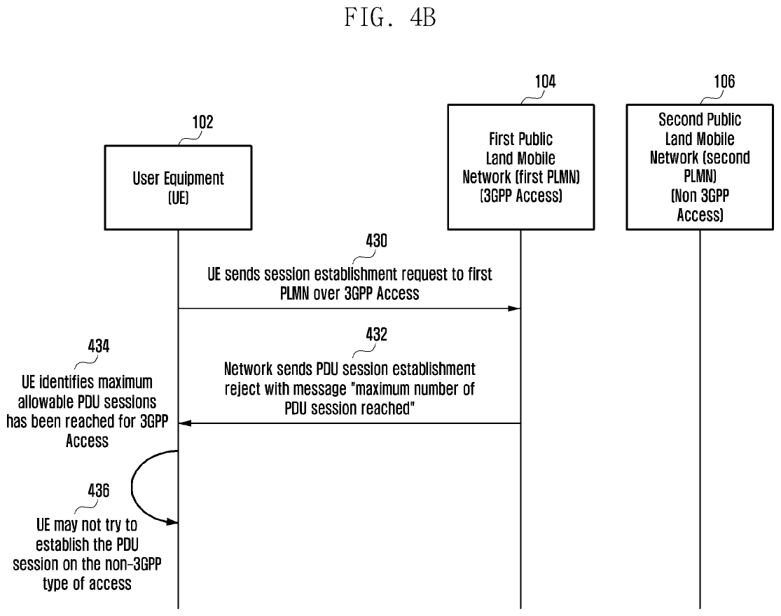

FIG. 4A illustrates an example of a flowchart of method for managing PDU sessions in wireless communication networks for the UE (102) registered for 3GPP access and non-3GPP access to the first PLMN (104) according to embodiments as disclosed herein.

At step 410, the UE (102) (102) registers with the first PLMN (104) for the first access and the second access. The first access and the second access may be one of the 3GPP access or the non-3GPP access. At step 412, the UE (102) maintains a count value for the number of active PDU sessions for the first access and the second access for the first PLMN (104). Here the count value is separate for each access type; i.e., the UE (102) maintains a first count value for the first access and a second count value for the second access.

For example, the UE (102) maintains the maximum number of PDU sessions for the first access as 3 and the maximum number of PDU sessions for the second access as 5. At step 414, the UE (102) checks if the count value for the maximum number of PDU sessions on the first PLMN (104) has been reached or not. At step 416, if the first count value is lower than the maximum number of PDU sessions for the first access on the first PLMN (104), then the UE (102) sends the PDU session establishment request for the first access to the first PLMN (104). For example, if the maximum number of PDU sessions for the first access is 3, if the UE (102) receives a PDU session establishment request, and the count value reaches 3, the UE (102) may not send any PDU session establishment request to the first PLMN (104) for the first access. If the second count value is lower than the maximum number of PDU sessions, then the UE (102) may send a PDU session establishment request to the first PLMN (104) for the second access. At step 418, as the PDU session has been established successfully with the first PLMN (104) for the second access for which the PDU session establishment request was sent, the second count value is updated and maintained after establishing the PDU session for the second access.

In an embodiment herein, if the first count value or the second count value for the active number of PDU session is equal to the maximum number of PDU sessions for the first access or the second access respectively has been reached, in step 420, the UE (102) may not send any further PDU establishment requests to the first PLMN (104) for that particular type of access (i.e., the first access or the second access), for which the maximum number of PDU sessions has been reached.

According to an embodiment herein, if the count value for the maximum number of PDU sessions has been reached for the first access and the second access, in step 422, the UE (102) checks continuously if any established PDU sessions for the first access and the second access has been released or not. If any one of the PDU session for the first access and the second access has been released, the UE (102) may send a PDU establishment request to the first PLMN (104) for any type of access, i.e., either 3GPP access or non-3GPP access, on which the established PDU session has been released.

In an embodiment herein, the UE (102) migrates or moves from the first PLMN (104) to the second PLMN (106). Once the UE (102) gets successfully registered on second PLMN (106), the UE (102) clears the first count value for the first PLMN (104) of the maximum number of PDU session for the first access. However, the UE (102) maintains the second count value for the second access on the first PLMN (104), as the UE (102) still has a registration for the second access on the first PLMN (104).

In an embodiment herein, the network entity may comprise a standalone non-public (SNPN) network. The SNPN registers via the PLMN over the first access and the second access.

In an embodiment herein, the first PLMN (104), the second PLMN (106), or any public land mobile network (PLMN) registers via the SNPN over the first access and the second access.

FIG. 4B illustrates an example of scenario of method for managing PDU sessions in wireless communication networks for the UE (102) registered for 3GPP access and non-3GPP access to the first PLMN (104) according to embodiments as disclosed herein. In step 430, the UE (102) registers with the first PLMN (104) over both 3GPP access and non-3GPP access. The UE (102) sends a PDU session establishment to the first PLMN (104) over 3GPP access. In step 432, the network sends the rejection message to the PDU session establishment reject to the UE (102) with 5GMM cause #65 “maximum number of PDU sessions reached” for 3GPP access. In step 434, the UE (102) checks if the network entity's maximum number of PDU sessions has been reached for the first access or the second access and maintains the first count value for the first access and the second count value for the second access, wherein the network entity can be the SNPN or the PLMN.

For example, if the UE (102) receives a PDU session establishment reject with 5GMM Cause #65 “maximum number of PDU sessions reached” in 3GPP access, then the UE (102) checks the number of active PDU sessions to check the maximum number of PDU sessions have been reached for 3GPP access and the non-3GPP access for the first PLMN (104) and maintains the maximum number of PDU session for the 3GPP access as the first count value and non-3GPP access as the second count value. Therefore, the UE (102) maintains the first count value and a second count separately, wherein the first count value is for the maximum number of PDU sessions for the first access and the second count value is for the maximum number of PDU sessions for the second access for the first PLMN (104). In step 436, the UE (102) checks whether the maximum number of PDU sessions has been established on the first access.

For example, consider that the maximum number of PDU sessions on a 3GPP access is five. If the UE (102) receives the rejection message for PDU session establishment with 5GMM Cause #65 “maximum number of PDU sessions reached” in 3GPP Access, then the UE (102) may maintain 5 as the maximum number of PDU sessions allowed for this PLMN ID first PLMN (104) over 3GPP access. The UE (102) sends PDU session establishment requests if the first count value of the active PDU sessions on the 3GPP access is lower than five. For example, consider that the maximum number of PDU sessions on a non-3GPP access is three, then the UE (102) sends the PDU session establishment request for the non-3GPP access (if the second count value for the active PDU sessions is less than the maximum number of PDU sessions over non-3GPP access). The UE (102) is allowed to send PDU session establishment requests till the maximum number of PDU session has been reached per access.

In an embodiment herein, the UE (102) receives the rejection message that the maximum number of established PDU sessions has been reached for the UE (102) and the upper layers of the UE (102). The UE (102) may not send the PDU session establishment request to the DNN over 3GPP access and non-3GPP access unless an established PDU session is released on the respective access type. For example, if the UE (102) has 5 PDU sessions on the 3GPP access and the UE (102) is maintaining 5 as the maximum number of PDU session count, then at least one of the 5 PDU sessions over 3GPP access may be released for the UE (102) to attempt to establish another PDU session over the 3GPP access.

In an embodiment of the method (300), the UE (102) may migrate or move from the first PLMN (104) to the second PLMN (106) for the first access. Once the UE (102) gets successfully registered on the second PLMN (106) moving from the first PLMN (104) for the first access, the UE (102) clears the first count value for the first PLMN (104) of the maximum number of PDU session for the first access. However, the UE (102) maintains the second count value for the second access on the first PLMN (104), as the UE (102) still has a registration for the second access on the first PLMN (104).

The various actions in method 300 and method 400 may be performed in the order presented, in a different order or simultaneously. Further, in some embodiments, some actions listed in FIG. 3A, FIG. 3B, FIG. 4A, and FIG. 4B may be omitted.

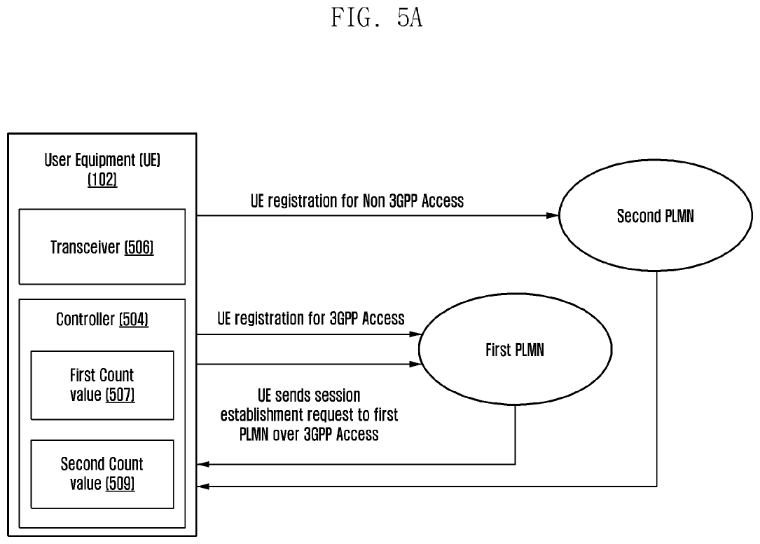

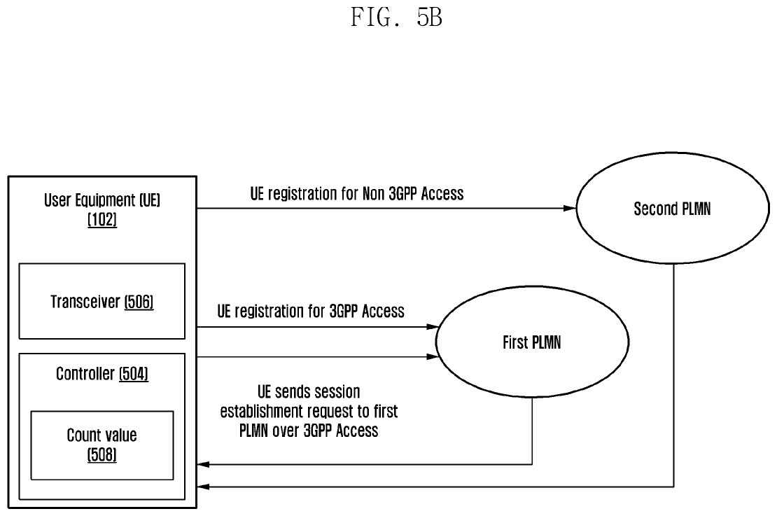

FIG. 5A illustrates an example of wireless network for managing protocol data units (PDU) sessions for a UE (102) registered with the first PLMN (104) for first access and second PLMN (106) for the second access according to embodiments as disclosed herein. The wireless network (200) can be, for example, but not limited to a fourth-generation wireless network, a 5^{th} generation wireless network, open radio access network (ORAN) or the like. The wireless network (500) includes the UE (102), a first network entity (NE) (104) and a second network entity (106). The first network entity (NE) (104) may be a PLMN or an SNPN. The second network entity (106) may be a PLMN or an SNPN.

Consider that the UE (102) is registered on two separate PLMNs for the 3GPP access and non-3GPP access. The UE (102) is registered with the first PLMN (104) for a first access and the second PLMN (106) for the second access. The first access and the second access comprise one or more of a 3GPP access and a non-3GPP access. The UE (102) is in communication with the first PLMN (104) and the second PLMN (106) for establishing the PDU session. The UE (102) comprises a controller (504) and a transceiver (206). The controller (504) communicates to the first PLMN (104) and the second PLMN (106) through the transceiver (506). The controller (504) sends the PDU session establishment request to the first PLMN (104) for the first access through the transceiver (506). The controller (504) may receive a rejection message for the PDU session establishment request for the first access from the first PLMN (104) when the maximum number of PDU session has been reached.

In an embodiment herein, the rejection message comprises a 5G mobile management (5GMM), and a 5G non access stratum mobile management (NAS-MM) with an indication or cause indicating that the maximum number of PDU sessions has been reached.

In an embodiment herein, the UE (102) maintains a separate count value for the number of active PDU sessions for a first access on the first PLMN (104) and a second access on the second PLMN (106). The UE (102) maintains the first count value for the first access on the first PLMN (104), and the second count value for the second access on the second PLMN (106) for the maximum number of PDU sessions established on each access.

In an embodiment herein, the controller (504) performs a check if the first count value and the second count value for the maximum number of PDU session has been reached, before sending a PDU session establishment request for any type of access. If the result of the check is that the first count value is lower than the maximum number of PDU sessions, then the controller (504) sends the PDU session establishment request for the first access to the first PLMN (104). If the controller (504) determines that the first count value has reached the maximum number of PDU sessions, and the second count value on the second PLMN (106) is lower than the maximum number of PDU sessions, then the controller (504) may try to send the PDU establishment request to the second PLMN (106) to establish the PDU session.

In an embodiment herein, the controller (504) performs a check on the first PLMN (104) for the first access and the second PLMN (106) for the second access, whether the established PDU session is released, in which the maximum number of PDU session has been reached. If the established PDU session is released on the first PLMN (104) for the first access, the controller sends the PDU session establishment request to the first PLMN (104) for the first access. In an embodiment herein, if the established PDU session is released on the second PLMN (106) for the second access, the controller (504) sends the PDU session establishment request to the second PLMN (106) for the second access.

In an embodiment herein, consider that the UE (102) migrates or moves from the first PLMN (104) to another PLMN for the first access or the second access. For an instance, consider that the UE (102) migrates or moves from the first PLMN (104) to a third PLMN (i.e., a third PLMN) for the first access. Once the UE (102) gets successfully registered on the third PLMN, the controller (504) clears the first count value for the first PLMN (104) of the maximum number of PDU session. The second count value remains as it is and is maintained for the second PLMN (106) for the second access, as there is no change of network entity for the second access.

In an embodiment herein, the network entity (NE) may comprise a standalone non-public (SNPN) network. The SNPN registers via the PLMN over the first access and the second access.

In an embodiment herein, the first PLMN (104), the second PLMN (106), or any public land mobile network (PLMN) registers via the SNPN over the first access and the second access.

In an embodiment herein, the UE (102) supports access to an SNPN using credentials from a credential's holder, and/or credentials from equivalent SNPNs. Once the UE (102) is registered over a first SNPN for the first access and a second SNPN for the second access for a selected entry of the “list of subscriber data,” the controller (504) checks the count value of the maximum number of PDU sessions. If the count value for the maximum number of PDU sessions has been reached for the first SNPN in the selected entry of the “list of subscriber data,” the UE (102) may move to the third PLMN in the same selected entry. In an embodiment herein, the UE (102) is registered over the first SNPN for the 3GPP access and the second SNPN for the non-3GPP access for a selected PLMN subscription. The controller (504) checks the count value for the maximum number of PDU sessions for the 3GPP access.

If the count value for the maximum number of PDU sessions has been reached for the first access for the selected PLMN subscription, the UE (102) may move to the third PLMN in the same selected entry. In an embodiment herein, the UE (102) is registered with the first SNPN for the first access and the second SNPN for the second access in the selected entry of the “list of subscriber data” or the selected PLMN subscription. The UE (102) maintains two separate count value for the first access and the second access. The UE (102) maintains the first count value for the first access on the first SNPN and the second count value for the second access on the second SNPN.

FIG. 5B illustrates an example of wireless network for managing PDU sessions when the UE (102) is registered with the first PLMN (104) and the second PLMN (106) according to embodiments as disclosed herein. In an embodiment herein, the UE (102) is registered with the first PLMN (104) for the first access and the second PLMN (106) for the second access. The first access and the second access can be one of a 3GPP access and a non-3GPP access. The UE (102) maintains a common count value (508) for the maximum number of PDU sessions for the first access on the first PLMN (104) and the second access on the second PLMN (106). The UE (102) is registered with the—first PLMN (104) for the first access and the second PLMN (106) for the second access. However, the count value is kept common for the first access and the second access in the present embodiment.

In an embodiment herein, the controller (504) performs a check for whether the maximum number of PDU sessions has been reached for both the first PLMN (104) for the first access and the second PLMN (106) for the second access. If the count value is lower than the maximum number of PDU sessions for both the first PLMN (104) and the second PLMN (106), the controller (504) sends a PDU establishment request to the first PLMN (104) or the second PLMN (106) for the 3GPP access or the non-3GPP access.

In an embodiment herein, the controller (504) sends the PDU session establishment request if the established session is released on any one of the first PLMN (104) or the second PLMN (106) for the first access or the second access.

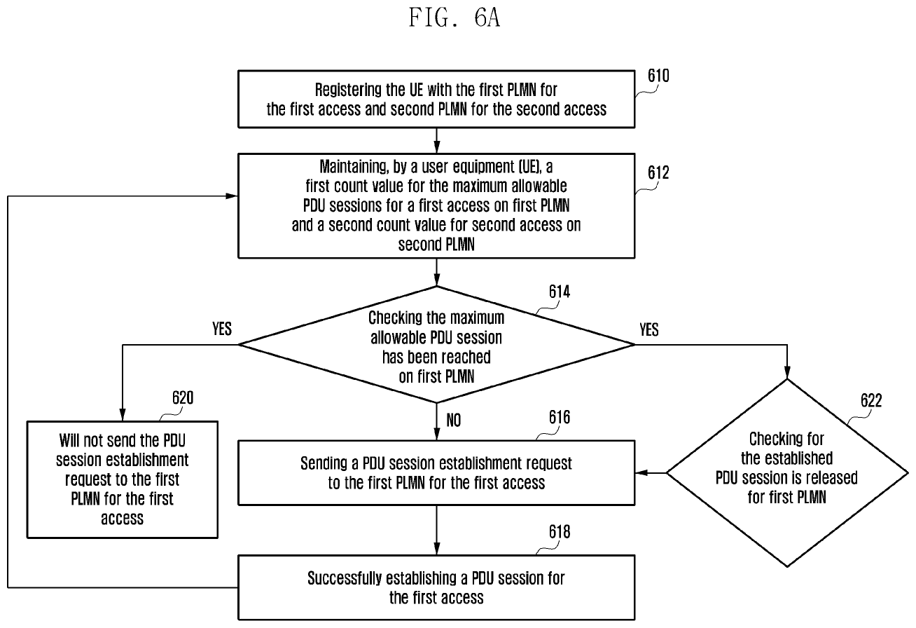

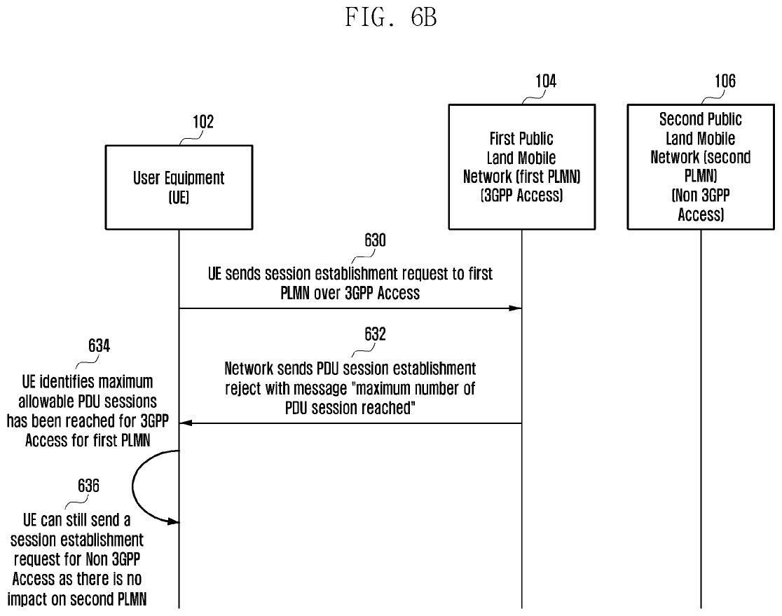

FIG. 6A illustrates an example of flowchart of method for managing PDU sessions in wireless communication networks for the UE (102) registered for 3GPP access to the first PLMN (104) and Non-3GPP access to the second PLMN (106) according to embodiments as disclosed herein.

At step 610, the UE (102) registers with the first PLMN (104) for the first access and the second PLMN (106) for the second access. The first access and the second access may be one of the 3GPP access or the non-3GPP access. At step 612, the UE (102) maintains the first count value for the number of active PDU sessions for the first access and the second count value for the number of active PDU sessions on the second access for second PLMN (106). Here the count value is separate for each access type; i.e., the UE (102) maintains the first count value for the first access on the first PLMN (104) and the second count value for the second access on the second PLMN (106). For example, the UE (102) maintains the maximum number of PDU sessions for the first access as 3 and the maximum number of PDU sessions for the second access as 5. At step 614, the UE (102) checks if the count value for the number of active PDU sessions on first PLMN (104) and the second PLMN (106) has been reached or not. If the first count value is lower than the maximum number of PDU sessions for the first access on first PLMN (104), at step 614, the UE (102) sends the PDU session establishment request for the first access to the first PLMN (104). For example, if the maximum number of PDU sessions for the first access is three and if the UE (102) receives a PDU session establishment request, and the count value is 3, the UE (102) may not send any PDU session establishment request to the first PLMN (104) for the first access.

However, the second count value is lower than the maximum number of PDU sessions, then the UE (102) may send a PDU session establishment request to the second PLMN (106) for the second access. At step 618, the PDU session is established successfully with the second PLMN (106) for the second access for which the PDU session establishment request was sent. The second count value is updated and maintained after establishing the PDU session for the second access.

In an embodiment herein, if the first count value or the second count value for the active number of PDU session is equal to the maximum number of PDU sessions for the first access or the second access respectively has been reached, in step 620, the UE (102) may not send any further PDU establishment requests to the first PLMN (104) and the second PLMN (106) for that particular type of access; i.e., the first access or the second access for which the maximum number of PDU sessions has been reached. According to another embodiment herein, if the count value for the maximum number of PDU sessions has been reached for any one of the first access and the second access, in step 622, the UE (102) checks continuously for any established PDU sessions with the first access and the second access has been released or not. If any one of the PDU session for the first access on the first PLMN (104) and the second access on the second PLMN (106) is released, the UE (102) may send a PDU establishment request to the first PLMN (104) or the second PLMN (106) on which the established PDU session has been released.

In an embodiment of the method (600), the UE (102) may migrate or move from the first PLMN (104) to the third PLMN for the first access. Once the UE (102) gets successfully registered on the third PLMN, the UE (102) clears the first count value for the first PLMN (104) of the maximum number of PDU session for the first access. However, the UE (102) maintains the second count value for the second access on the second PLMN (106), as the UE (102) still has a registration for the second access on the second PLMN (106).

FIG. 6B illustrates an example of scenario of method for managing PDU sessions in wireless communication networks for the UE (102) registered for 3GPP access to the first PLMN (104) and non-3GPP access to the second PLMN (106) according to embodiments as disclosed herein.

At step 630, the UE (102) registers with the first PLMN (104) over 3GPP access and the second PLMN (106) over non-3GPP access. The UE (102) sends a PDU session establishment to the first PLMN (104) over the 3GPP Access. In an embodiment herein, the first PLMN can be a SNPN network. At step 632, the UE (102) receives the rejection message for the PDU session establishment from the first PLMN (104) with 5GMM cause #65 “maximum number of PDU sessions reached.” At step 634, the UE (102) checks if the first PLMN's and the second PLMN's active number of PDU session for each type of access and maintains the first count value for the first PLMNs and the second count value for the second PLMN for tracking the maximum number of PDU sessions has been reached for the first PLMN and the second PLMN.

For example, the UE (102) connects to the first PLMN (104) over 3GPP access and second PLMN (106) over non-3GPP access. The UE (102) sends a PDU session establishment request message over 3GPP access to the first PLMN (104). If the UE (102) receives the PDU session establishment reject message with 5GMM cause #65 “maximum number of PDU sessions reached” for the 3GPP Access, then the UE (102) maintains that the maximum number of PDU sessions have been reached for 3GPP access for the first PLMN (104). The UE (102) maintains the first count value for the number of PDU sessions for 3GPP access over the first PLMN (104) and the second count value for non-3GPP access over the second PLMN (106).

For example, consider that the UE (102) has 5 PDU sessions established on 3GPP access registered with the first PLMN (104). If the UE (102) receives the rejection message for PDU session establishment with 5GMM Cause #65 “maximum number of PDU sessions reached” for the 3GPP Access on the first PLMN (104), then the UE (102) maintains 5 as the maximum number of PDU sessions allowed for the first PLMN (104) over 3GPP access. Similarly, if the UE (102) has 3 PDU sessions established on non-3GPP access registered with the second PLMN (106), and the UE (102) receives the rejection message for PDU session establishment with 5GMM Cause #65 “maximum number of PDU sessions reached” in non-3GPP Access, then the UE (102) maintains 3 as the maximum number of PDU sessions allowed for the second PLMN (106) over non-3GPP access.

The UE (102) is allowed to send a PDU session establishment request till the maximum count has been reached per PLMN on the respective access. In an example, if the maximum number of PDU session on first PLMN (104) for 3GPP access is five and the maximum number of PDU session on second PLMN (106) for non-3GPP access is three, the UE (102) sends a PDU session establishment request only if the first count value is lower than 5 for the first access over 3GPP access. Similarly, the UE (102) sends the PDU session establishment request only if the second count value is lower than three over non-3GPP access.

For example, consider that the UE (102) is registered for a first access or the second access to the first PLMN (104), if the maximum number of PDU sessions have been reached at the UE (102) for the first PLMN (104) and the upper layers of the UE (102) requests connectivity to the DNN over the first PLMN (104) for at least one of 3GPP access or the non-3GPP access. The UE (102) may then not send a PDU session establishment request message over that PLMN for 3GPP access or the non-3GPP access unless an established PDU session is released over that PLMN on the respective access type; e.g., 3GPP access in which “maximum number of PDU sessions reached.” In the above example, if the UE (102) has 5 PDU sessions on the first PLMN (104) for 3GPP access and the UE (102) is maintaining 5 as maximum number of PDU sessions for the first PLMN (104) for 3GPP access, then the UE (102) may release one of the five 5 established PDU sessions and then attempt to establish the new PDU session over the first PLMN (104) for 3GPP access.

In an embodiment herein, the UE (102) may migrate or move from the first PLMN (104) to the third PLMN for the first access. Once the UE (102) gets successfully registered on the third PLMN, the UE (102) clears the first count value for the first PLMN (104) of the maximum number of PDU session for the first access. However, the UE (102) maintains the second count value for the second access on the first PLMN (104), as the UE (102) still has a registration for the second access on the first PLMN (104). For example, if the UE (102) has 5 PDU sessions on the first PLMN (104) for 3GPP access and 3 PDU sessions on the second PLMN for non-3GPP access. The UE (102) maintains 5 as the maximum number of PDU sessions on the first PLMN (104) for 3GPP access. If the UE (102) registers with the third PLMN on 3GPP access, then the UE (102) may clear the previous first count value representing 5 as the first PLMN (104)'s maximum number of PDU sessions for 3GPP access. However, the UE (102) may continue to maintain that 3 is the maximum count of PDU session for the second PLMN (106) over non-3GPP access.

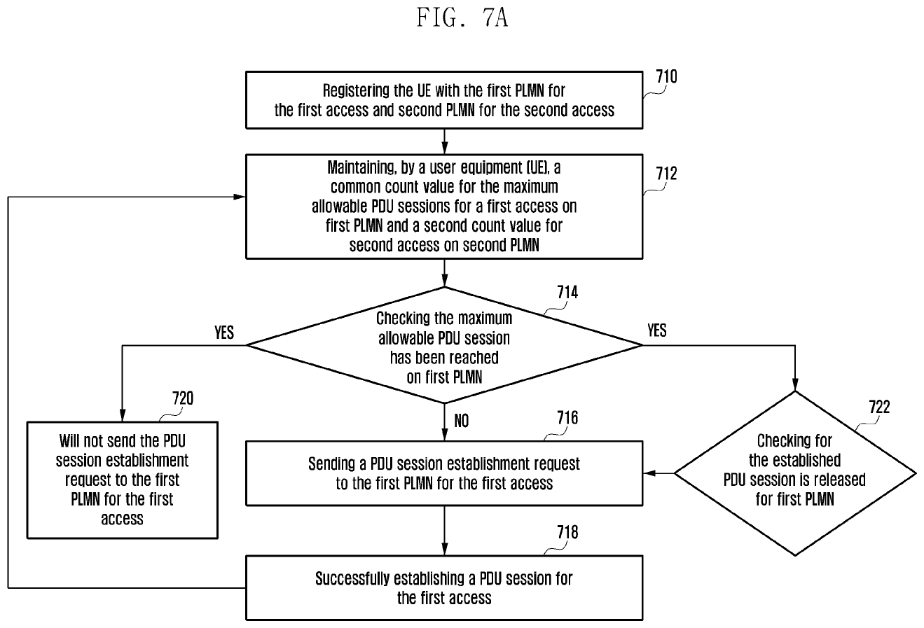

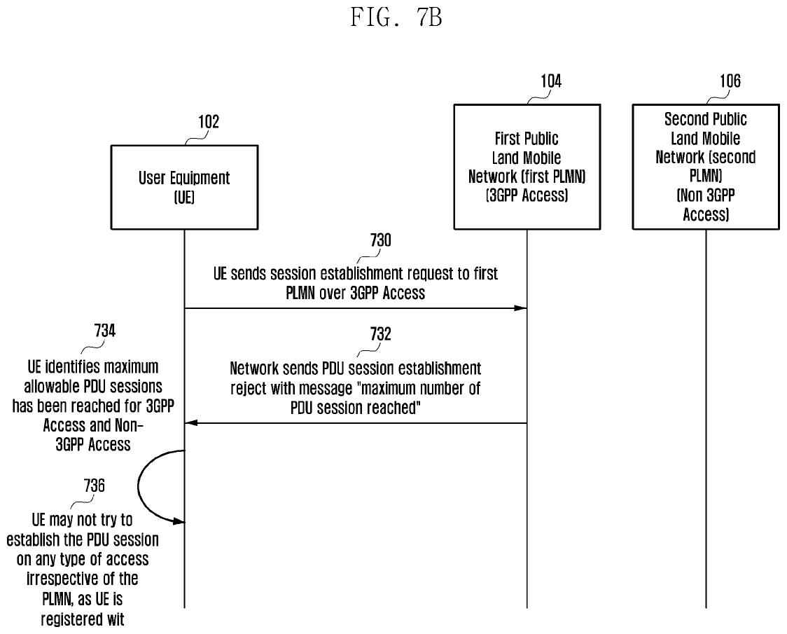

FIG. 7A illustrates an example of flowchart of method 700 for managing PDU sessions in wireless communication networks for the UE (102) registered for 3GPP access to the first PLMN (104) and Non-3GPP access to the second PLMN (106) according to embodiments as disclosed herein.

At step 710, the UE (102) registers with the first PLMN (104) for the first access and the second PLMN (106) for the second access. The first access and the second access may be one of the 3GPP access or the non-3GPP access. At step 712, the UE (102) maintains a common count value for both of the first access and the second access, though the UE (102) is registered separately on the first PLMN (104) for the first access and the second PLMN (106) for the second access. For example, the first access registered over the first PLMN (104) has 5 as the maximum number of PDU sessions and the second access registered over the second PLMN (106) has 3 as the maximum number of PDU sessions. Therefore, the UE (102) maintains the count value that is common for the first access (i.e., 5) in addition to 3 of the second access, therefore the count value for this scenario is 8. At step 714, the UE (102) checks if the count value for the maximum number of PDU sessions on first PLMN (104) and the second PLMN (106) has been reached or not. If the count value is lower than the maximum number of PDU sessions for the first access on first PLMN (104) and the second access on the second PLMN (106), in step 716, the UE (102) may send the session establishment request to any of the PLMNs (i.e., the first PLMN (104) or the second PLMN (106)), for the first access or the second access respectively.

For example, consider that the maximum PDU sessions for the first access and the second access is eight. On checking, the UE (102) receives that the count value that is common for the active PDU sessions is 5 for the first access in addition to the second access, the UE (102) sends a session establishment request for the first access or the second access to the first PLMN (104) or the second PLMN (106) respectively. At step 718, the PDU session is established successfully with the first PLMN (104) or the second PLMN (106) for the first access or the second access for which the PDU session establishment request was sent. The count value is updated and maintained after establishing the PDU session for a second access.

In an embodiment herein, if the count value for the active number of PDU session is equal to the maximum number of PDU sessions for the first access or the second access respectively has been reached, in step 720, the UE (102) may not send any further PDU establishment requests to the first PLMN (104) and the second PLMN (106) for that particular type of access, i.e., the first access or the second access for which the maximum number of PDU sessions has been reached. According to another embodiment herein, if the count value for the maximum number of PDU sessions has been reached for the first access and the second access, in step 722, the UE (102) checks continuously if any established PDU sessions has been released or not, in which the maximum PDU sessions has been reached. If any one of the PDU session for the first access on the first PLMN (104) and the second access on the second PLMN (106) is released, the UE (102) may send a PDU establishment request to the first PLMN (104) or the second PLMN (106) on which the established PDU session has been released.

FIG. 7B illustrates an example of scenario for the UE (102) registered for 3GPP access to the first PLMN (104) and non-3GPP access to the second PLMN (106) according to embodiments as disclosed herein.

At step 730, the UE (102) registers with first PLMN (104) over 3GPP access and second PLMN (106) over non-3GPP access. The UE (102) sends a PDU session establishment to the first PLMN (104) over 3GPP Access. The network entity herein may be a SNPN network or a standard PLMN network. At step 732, the UE (102) receives the rejection message for PDU session establishment from the first PLMN (104) with 5GMM cause #65 “maximum number of PDU sessions reached” for 3gpp access. At step 634, the UE (102) checks if the network entity's active number of PDU session for each type of access, that is 3GPP and non-3GPP access and maintains the SNPN's or PLMNs the count value for tracking the maximum number of PDU sessions has been reached for any access type.

For example, the UE (102) connects over first PLMN (104) over 3GPP access and second PLMN (106) over non-3GPP access. The UE (102) sends a PDU session establishment request message over 3GPP access to the first PLMN (104). If the UE (102) receives the rejection message for PDU session establishment with 5GMM Cause #65 “maximum number of PDU sessions reached” in 3GPP Access, then the UE (102) maintains that the maximum number of PDU sessions have been reached for both 3GPP and N3GPP access for the first access and the second access. So, the UE (102) maintains a count value that is common for the maximum number of PDU sessions reached for both access types across PLMNs that is the first access over the first PLMN (104) and the second access over the second PLMN (106). The UE (102) may not try to establish PDU sessions over any access type that is 3GPP access or non-3GPP access over the first PLMN (104) and the second PLMN (106).

For example, consider that the UE (102) has 5 PDU sessions established on 3GPP access registered with the first PLMN (104), and the UE (102) has 3 PDU sessions established on non-3GPP access registered with second PLMN (106). If the UE (102) receives the rejection message for PDU session establishment with 5GMM Cause #65 “maximum number of PDU sessions reached” in either 3GPP access or non-3GPP Access, then the UE (102) maintains eight as the maximum number of PDU sessions allowed together over all the available accesses of the UE (102); i.e., the 3GPP access, and the non-3GPP access.

In an embodiment herein, the UE (102) attempts to send a PDU session establishment request only if the count value is lower than 8 on the first PLMN (104) and the second PLMN (106) for 3GPP access or non-3GPP access respectively. The UE (102) may send a PDU session establishment request till the maximum count 8 has been reached on any of the first PLMN (104) and the second PLMN (106) for the 3GPP access or non-3GPP access.

In an embodiment herein, if the maximum number of established PDU sessions has been reached at the UE (102) over the first PLMN (104) and second PLMN (106) and the upper layers of the UE (102) request connectivity to a DNN over the 3GPP or the non-3GPP access, the UE (102) may not send a PDU session establishment request message on any of the first access and the second access unless at least one established PDU session has been released on any of the first PLMN (104) or the second PLMN (106). For example, consider that the UE (102) has 8 PDU sessions on the first access and the second access. The UE (102) maintains 8 as the maximum number of PDU sessions as the count value, then the UE (102) attempts to establish a PDU session when at least one of the 8 PDU sessions over either the first PLMN (104) for 3GPP access or the second PLMN (106) for non-3GPP access has been released.

In an embodiment herein, the UE (102) may migrate or move from the first PLMN (104) to the third PLMN for the 3GPP access. The UE (102) may clear the previous count value for the first PLMN (104) for 3GPP access, as the UE (102) is successfully registered on the third PLMN. For example, consider that the UE (102) has 8 PDU sessions for the first access and the second access, and the UE (102) is maintaining 8 as maximum number of PDU session. If the UE (102) registers with the third PLMN on any access type that is 3GPP access or non-3GPP access, the UE (102) may clear the previous count value determined for the first PLMN (104) representing 8 as the maximum number of PDU sessions.

In an embodiment herein, the rejection message for PDU session establishment reject with 5GMM Cause #65 “maximum number of PDU sessions reached” comprises both the UE (102) receiving the rejection message from the session management function (SMF) or the access and mobility management function (AMF). The SMF or the AMF sends a downlink decoupling non-access stratum (DL NAS) transport after setting the 5th generation mobility management (5GMM) cause information element (IE) to the 5GMM cause #65 “maximum number of PDU sessions reached.” The rejection message may be one of a single mode (SM) or a multi mode (MM) message received by the UE (102) with an indication or cause indicating that the maximum number of PDU sessions have been reached.

In an embodiment herein, consider that the UE (102) is registered with the first PLMN (104) over 3GPP access and PLMN-2 over non-3GPP access. The UE (102) may clear the previous count value representing the first PLMN (104) maximum number(s) of PDU sessions, when a UE (102) moves from the first PLMN (104) to the third PLMN. The UE (102) may maintain the second count value representing the second PLMN (106)'s maximum number of PDU sessions as there is no change in the registration of the non-3GPP access over the second PLMN (106).

In an embodiment herein, consider that the UE (102) is registered with the first PLMN (104) over 3GPP access and the second PLMN (106) over non-3GPP access. If the UE (102) moves from the second PLMN (106) and registers with the third PLMN over non-3GPP access, then the UE (102) may clear the previous second count value for the second PLMN's (106) maximum number(s) of PDU sessions. The UE (102) may maintain the first count value representing the first PLMN (104)'s maximum number of PDU sessions as there is no change in the registration of the 3GPP access over first PLMN (104).

In an embodiment herein, consider that the UE (102) is registered with the first PLMN (104) for both 3GPP and non-3GPP access. The UE (102) then clears the count value of the maximum number of PDU session only when the UE (102) moves from the first PLMN (104) to another PLMN (say, the third PLMN) for both the accesses. The UE (102) clears the count value of the maximum number of PDU session for the first PLMN (104) if the first PLMN (104) is no longer registered for 3GPP access and non-3GPP access. If the UE (102) remains registered with at least one of the access, then the UE (102) may maintain the previous count value for the first PLMN's (104) maximum number(s) of PDU sessions.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for managing protocol data unit (PDU) sessions in a wireless communication system, the method comprising:
maintaining, by a user equipment (UE), a count value for a maximum number of PDU sessions for a first access and a second access on a first network entity (NE), wherein the count value is common for the first access and the second access when the first access and the second access identify the first NE as a a same NE; and
sending, by the UE, a PDU session establishment request when the UE determines a number of active PDU sessions is lower than the count value for the maximum number of PDU sessions or an established PDU session is released on at least one of the first access or the second access in which the maximum number of PDU sessions has been reached.

2. The method as claimed in claim 1, further comprising:
sending, by the UE, the PDU session establishment request to the first NE for the first access, wherein the UE is registered with the first NE for the first access and the second access; and
receiving, by the UE, a rejection message for the PDU session establishment request for the first access from the first NE when the maximum number of PDU sessions has been reached.

3. The method as claimed in claim 1, wherein the first access comprises one of a 3^{rd} generation partnership project (3GPP) access or a non-3GPP (N-3GPP) access, and wherein the second access comprises one of the 3GPP access or the N-3GPP access.

4. The method as claimed in claim 1, wherein a rejection message comprises at least one of a 5G mobile management (5GMM) or 5G non access stratum mobile management (NAS-MM) with an indication indicating a maximum number of PDU sessions reached message and a cause #65 indication indicating a maximum number of PDU sessions reached message.

5. The method as claimed in claim 1, further comprising:
clearing, by the UE, the count value for the first NE of the maximum number of PDU sessions when the first NE is no longer registered over both the first access and the second access and the UE is successfully registered with a second NE, the UE being moving from the first NE.

6. The method as claimed in claim 5, wherein the first NE comprises one of a first public land mobile network (PLMN), a second PLMN, or a standalone non-public network (SNPN), and wherein the second NE comprises one of the first PLMN, second PLMN, or the SNPN.

7. The method as claimed in claim 6, further comprising:
registering, by the UE, to second SNPN for at least one of an entry from a list of subscriber data and a selected PLMN subscription, if the UE supports an access to the SNPN using credentials from at least one of credential holders and to equivalent SNPNs when the count value is equal to the maximum number of PDU sessions for the SNPN for at least one of the entry of the list of subscriber data or the selected PLMN subscription.

8. The method as claimed in claim 7, further comprising:
maintaining, by the UE, a first count value for the first access and a second count value for the second access in the entry of the list of subscriber data and the selected PLMN subscription when the UE is registered on a first SNPN for the first access and a second SNPN for the second access and the UE is registered on the first SNPN for the first access and the second access.

9. A method performed by a user equipment (UE) in a wireless communication system, the method comprising:
maintaining, by a user equipment (UE), a first count value for a maximum number of protocol data unit (PDU) sessions for a first access on a first network entity (NE) and a second count value for a second access on a second NE; and
sending, by the UE, a PDU session establishment request when the UE determines that a number of active PDU sessions is lower than the first count value and the second count value for the maximum number of PDU sessions and an established PDU session is released on at least one of the first access or the second access in which the maximum number of PDU sessions has been reached.

10. The method as claimed in claim 9, further comprising:
sending, by the UE, the PDU session establishment request to the first NE for the first access, wherein the UE is registered with the first NE for the first access and the second NE for the second access; and
receiving, by the UE, a rejection message for the PDU session establishment request for the first access from the first NE when the maximum number of PDU sessions has been reached.

11. The method as claimed in claim 9, further comprising:
clearing, by the UE, the first count value for the first access corresponding to the maximum number of PDU sessions in the first NE; and
maintaining, by the UE, the second count value for the second access in the second NE when the UE is registered with a third NE, the UE being moving from the first NE.

12. The method as claimed in claim 9, further comprising:
sending, by the UE, a PDU session establishment request when the first count value is lower than a maximum number of allowable PDU sessions in the first NE when the second count value for the second NE has reached the maximum number of PDU sessions.

13. The method as claimed in claim 9, further comprising:
sending, by the UE, a PDU session establishment request when the second count value is lower than a maximum number of allowable PDU sessions in the second NE when the first count value for the first NE has reached the maximum number of PDU sessions.

14. A user equipment (UE) in a wireless communication system, wherein the UE comprising:
a transceiver; and
at least one controller coupled with the transceiver and configured to:
maintain a count value for a maximum number of PDU sessions for a first access and a second access on a first network entity (NE), wherein the count value is common for the first access and the second access when the first access and the second access identify the first NE as a same NE, and
send a PDU session establishment request when the UE determines a number of active PDU sessions is lower than the count value for the maximum number of PDU sessions or an established PDU session is released on at least one of the first access or the second access in which the maximum number of PDU sessions has been reached.

15. A user equipment (UE) in a wireless communication system, the UE comprising:
a transceiver; and
at least one controller coupled with the transceiver and configured to:
maintain a first count value for a maximum number of protocol data unit (PDU) sessions for a first access on a first network entity (NE) and a second count value for a second access on a second NE; and
send a PDU session establishment request when the UE determines that a number of active PDU sessions is lower than the first count value and the second count value for the maximum number of PDU sessions and an established PDU session is released on at least one of the first access or the second access in which the maximum number of PDU sessions has been reached.

16. The UE as claimed in claim 15, wherein the first NE comprises one of a first public land mobile network (PLMN), a second PLMN, or a standalone non-public network (SNPN), and wherein the second NE comprises one of the first PLMN, second PLMN, or the SNPN.

17. The UE as claimed in claim 16, wherein the SNPN registers via the first PLMN, the second PLMN, and a third PLMN over the first access and the second access.

18. The UE as claimed in claim 16, wherein the first PLMN, the second PLMN, and a third PLMN register via the SNPN over the first access and the second access.
